(19) United States
(12) Patent Application Publication
(10) Pub. No.: US 2022/0012954 A1
(43) Pub. Date: Jan. 13, 2022

(54) GENERATION OF SYNTHETIC THREE-DIMENSIONAL IMAGING FROM PARTIAL DEPTH MAPS

(71) Applicant: Activ Surgical, Inc., Boston, MA (US)

(72) Inventor: Vasiliy E. Buharin, Arlington, MA (US)

(21) Appl. No.: 17/349,713

(22) Filed: Jun. 16, 2021

Related U.S. Application Data
(63) Continuation of application No. PCT/US19/68760, filed on Dec. 27, 2019.
(60) Provisional application No. 62/785,950, filed on Dec. 28, 2018.

(51) Int. Cl. G06T 19/20; G06T 7/73; G06T 5/00; G06T 5/50

(52) U.S. Cl. CPC G06T 19/20; G06T 7/75; G06T 5/002; G06T 5/50; G06T 2210/41; G06T 2219/2004; G06T 2200/24; G06T 2207/10028; G06T 2210/56; G06T 2219/2016

(57) ABSTRACT

Generation of synthetic three-dimensional imaging from partial depth maps is provided. In various embodiments, an image of an anatomical structure is received from a camera. A depth map corresponding to the image is received from a depth sensor that may be a part of the camera or separate from the camera. A preliminary point cloud corresponding to the anatomical structure is generated based on the depth map and the image. The preliminary point cloud is registered with a model of the anatomical structure. An augmented point cloud is generated from the preliminary point cloud and the model. The augmented point cloud is rotated in space. The augmented point cloud is rendered. The rendered augmented point cloud is displayed to a user.

### CROSS-REFERENCE TO RELATED APPLICATION

This application is a continuation of International PCT Application No. PCT/US2019/068760, filed on Dec. 27, 2019, which claims priority to U.S. Provisional Patent Application No. 62/785,950, filed on Dec. 28, 2018, each of which is incorporated herein by reference in its entirety for all purposes.

### BACKGROUND

Embodiments of the present disclosure relate to synthetic three-dimensional imaging, and more specifically, to generation of synthetic three-dimensional imaging from partial depth maps.

### BRIEF SUMMARY

According to embodiments of the present disclosure, methods of and computer program products for synthetic three-dimensional imaging are provided. In various embodiments, a method is performed where an image of an anatomical structure is received from a camera. A depth map corresponding to the image is received from a depth sensor that may be a part of the camera or separate from the camera. A point cloud corresponding to the anatomical structure is generated based on the depth map and the image. The point cloud is rotated in space. The point cloud is rendered. The rendered point cloud is displayed to a user.

In various embodiments, the point cloud is a preliminary point cloud. In various embodiments, the preliminary point cloud is registered with a model of the anatomical structure. In various embodiments, an augmented point cloud is generated from the preliminary point cloud and the model. In various embodiments, the augmented point cloud is rotated in space, rendered, and displayed to the user.

In various embodiments, an indication is received from the user to further rotate the augmented point cloud, the augmented point cloud is rotated in space according to the indication, the augmented point cloud is rendered after further rotating, and the rendered augmented point cloud is displayed to the user after further rotating. In various embodiments, the camera includes the depth sensor. In various embodiments, the camera is separate from the depth sensor. In various embodiments, the depth sensor includes a structure light sensor and a structured light projector. In various embodiments, the depth sensor comprises a time-of-flight sensor. In various embodiments, the depth map is determined from a single image frame. In various embodiments, the depth map is determined from two or more image frames.

In various embodiments, the method further includes generating a surface mesh from the preliminary point cloud. In various embodiments, generating a surface mesh includes interpolating the preliminary point cloud. In various embodiments, interpolating is performed directly. In various embodiments, interpolating is performed on a grid. In various embodiments, interpolating includes splining. In various embodiments, prior to generating a surface mesh, the preliminary point cloud may be segmented into two or more sematic regions. In various embodiments, generating a surface mesh comprises generating a separate surface mesh for each of the two or more sematic regions. In various embodiments, the method further includes combining each of the separate surface meshes into a combined surface mesh. In various embodiments, the method further includes displaying the combined surface mesh to the user.

In various embodiments, the model of the anatomical structure comprises a virtual 3D model. In various embodiments, the model of the anatomical structure is determined from an anatomical atlas. In various embodiments, the model of the anatomical structure is determined from pre-operative imaging of the patient. In various embodiments, the model of the anatomical structure is a 3D reconstruction from the pre-operative imaging. In various embodiments, the pre-operative imaging may be retrieved from a picture archiving and communications system (PACS). In various embodiments, registering comprises a deformable registration. In various embodiments, registering comprises a rigid body registration. In various embodiments, each point in the point cloud comprises a depth value derived from the depth map and a color value derived from the image.

In various embodiments, a system is provided including a digital camera configured to image an interior of a body cavity, a display, and a computing node including a computer readable storage medium having program instructions embodied therewith. The program instructions are executable by a processor of the computing node to cause the processor to perform a method where an image of an anatomical structure is received from a camera. A depth map corresponding to the image is received from a depth sensor that may be a part of the camera or separate from the camera. A point cloud corresponding to the anatomical structure is generated based on the depth map and the image. The point cloud is rotated in space. The point cloud is rendered. The rendered point cloud is displayed to a user.

In various embodiments, the point cloud is a preliminary point cloud. In various embodiments, the preliminary point cloud is registered with a model of the anatomical structure. In various embodiments, an augmented point cloud is generated from the preliminary point cloud and the model. In various embodiments, the augmented point cloud is rotated in space, rendered, and displayed to the user.

In various embodiments, an indication is received from the user to further rotate the augmented point cloud, the augmented point cloud is rotated in space according to the indication, the augmented point cloud is rendered after further rotating, and the rendered augmented point cloud is displayed to the user after further rotating. In various embodiments, the camera includes the depth sensor. In various embodiments, the camera is separate from the depth sensor. In various embodiments, the depth sensor includes a structure light sensor and a structured light projector. In various embodiments, the depth sensor comprises a time-of-flight sensor. In various embodiments, the depth map is determined from a single image frame. In various embodiments, the depth map is determined from two or more image frames.

In various embodiments, the method further includes generating a surface mesh from the preliminary point cloud. In various embodiments, generating a surface mesh includes interpolating the preliminary point cloud. In various embodiments, interpolating is performed directly. In various embodiments, interpolating is performed on a grid. In various embodiments, interpolating includes splining. In various embodiments, prior to generating a surface mesh, the preliminary point cloud may be segmented into two or more sematic regions. In various embodiments, generating a surface mesh comprises generating a separate surface mesh for each of the two or more sematic regions. In various embodiments, the method further includes combining each of the separate surface meshes into a combined surface mesh. In various embodiments, the method further includes displaying the combined surface mesh to the user.

In various embodiments, the model of the anatomical structure comprises a virtual 3D model. In various embodiments, the model of the anatomical structure is determined from an anatomical atlas. In various embodiments, the model of the anatomical structure is determined from pre-operative imaging of the patient. In various embodiments, the model of the anatomical structure is a 3D reconstruction from the pre-operative imaging. In various embodiments, the pre-operative imaging may be retrieved from a picture archiving and communications system (PACS). In various embodiments, registering comprises a deformable registration. In various embodiments, registering comprises a rigid body registration. In various embodiments, each point in the point cloud comprises a depth value derived from the depth map and a color value derived from the image.

In various embodiments, a computer program product for synthetic three-dimensional imaging is provided including a computer readable storage medium having program instructions embodied therewith. The program instructions are executable by a processor of the computing node to cause the processor to perform a method where an image of an anatomical structure is received from a camera. A depth map corresponding to the image is received from a depth sensor that may be a part of the camera or separate from the camera. A point cloud corresponding to the anatomical structure is generated based on the depth map and the image. The point cloud is rotated in space. The point cloud is rendered. The rendered point cloud is displayed to a user.

In various embodiments, the point cloud is a preliminary point cloud. In various embodiments, the preliminary point cloud is registered with a model of the anatomical structure. In various embodiments, an augmented point cloud is generated from the preliminary point cloud and the model. In various embodiments, the augmented point cloud is rotated in space, rendered, and displayed to the user.

In various embodiments, an indication is received from the user to further rotate the augmented point cloud, the augmented point cloud is rotated in space according to the indication, the augmented point cloud is rendered after further rotating, and the rendered augmented point cloud is displayed to the user after further rotating. In various embodiments, the camera includes the depth sensor. In various embodiments, the camera is separate from the depth sensor. In various embodiments, the depth sensor includes a structure light sensor and a structured light projector. In various embodiments, the depth sensor comprises a time-of-flight sensor. In various embodiments, the depth map is determined from a single image frame. In various embodiments, the depth map is determined from two or more image frames.

In various embodiments, the method further includes generating a surface mesh from the preliminary point cloud. In various embodiments, generating a surface mesh includes interpolating the preliminary point cloud. In various embodiments, interpolating is performed directly. In various embodiments, interpolating is performed on a grid. In various embodiments, interpolating includes splining. In various embodiments, prior to generating a surface mesh, the preliminary point cloud may be segmented into two or more sematic regions. In various embodiments, generating a surface mesh comprises generating a separate surface mesh for each of the two or more sematic regions. In various embodiments, the method further includes combining each of the separate surface meshes into a combined surface mesh. In various embodiments, the method further includes displaying the combined surface mesh to the user.

In various embodiments, the model of the anatomical structure comprises a virtual 3D model. In various embodiments, the model of the anatomical structure is determined from an anatomical atlas. In various embodiments, the model of the anatomical structure is determined from pre-operative imaging of the patient. In various embodiments, the model of the anatomical structure is a 3D reconstruction from the pre-operative imaging. In various embodiments, the pre-operative imaging may be retrieved from a picture archiving and communications system (PACS). In various embodiments, registering comprises a deformable registration. In various embodiments, registering comprises a rigid body registration. In various embodiments, each point in the point cloud comprises a depth value derived from the depth map and a color value derived from the image.

### BRIEF DESCRIPTION OF THE SEVERAL VIEWS OF THE DRAWINGS

FIG. 1 depicts a system for robotic surgery according to embodiments of the present disclosure.

FIGS. 2A-2B shows a first synthetic view according to embodiments of the present disclosure.

FIGS. 3A-3B shows a second synthetic view according to embodiments of the present disclosure.

FIGS. 4A-4B shows a third synthetic view according to embodiments of the present disclosure.

FIG. 5A shows a kidney according to embodiments of the present disclosure. FIG. 5B shows a point cloud of the kidney shown in FIG. 5A according to embodiments of the present disclosure.

FIG. 6A shows a kidney according to embodiments of the present disclosure. FIG. 6B shows an augmented point cloud of the kidney shown in FIG. 6A according to embodiments of the present disclosure.

FIG. 7 illustrates a method of synthetic three-dimensional imaging according to embodiments of the present disclosure.

FIG. 8 depicts an exemplary Picture Archiving and Communication System (PACS).

FIG. 9 depicts a computing node according to an embodiment of the present disclosure.

### DETAILED DESCRIPTION

An endoscope is an illuminated optical, typically slender and tubular instrument (a type of borescope) used to look within the body. An endoscope may be used to examine internal organs for diagnostic or surgical purposes. Specialized instruments are named after their target anatomy, e.g., the cystoscope (bladder), nephroscope (kidney), bronchoscope (bronchus), arthroscope (joints), colonoscope (colon), laparoscope (abdomen or pelvis).

Laparoscopic surgery is commonly performed in the abdomen or pelvis using small incisions (usually 0.5-1.5 cm) with the aid of a laparoscope. The advantages of such minimally invasive techniques are well-known, and include reduced pain due to smaller incisions, less hemorrhaging, and shorter recovery time as compared to open surgery.

A laparoscope may be equipped to provide a two-dimensional, image, a stereo image, or a depth field image (as described further below).

Robotic surgery is similar to laparoscopic surgery insofar as it also uses small incisions, a camera and surgical instruments. However, instead of holding and manipulating the surgical instruments directly, a surgeon uses controls to remotely manipulate the robot. A console provides the surgeon with high-definition images, which allow for increased accuracy and vision.

An image console can provide three-dimensional, high definition, and magnified images. Various electronic tools may be applied to further aid surgeons. These include visual magnification (e.g., the use of a large viewing screen that improves visibility) and stabilization (e.g., electromechanical damping of vibrations due to machinery or shaky human hands). Simulator may also be provided, in the form of specialized virtual reality training tools to improve physicians' proficiency in surgery.

In both robotic surgery and conventional laparoscopic surgery, a depth field camera may be used to collect a depth field at the same time as an image.

An example of a depth field camera is a plenoptic camera that uses an array of micro-lenses placed in front of an otherwise conventional image sensor to sense intensity, color, and distance information. Multi-camera arrays are another type of light-field camera. The standard plenoptic camera is a standardized mathematical model used by researchers to compare different types of plenoptic (or light-field) cameras. By definition the standard plenoptic camera has microlenses placed one focal length away from the image plane of a sensor. Research has shown that its maximum baseline is confined to the main lens entrance pupil size which proves to be small compared to stereoscopic setups. This implies that the standard plenoptic camera may be intended for close range applications as it exhibits increased depth resolution at very close distances that can be metrically predicted based on the camera's parameters. Other types/orientations of plenoptic cameras may be used, such as focused plenoptic cameras, coded aperture cameras, and/or stereo with plenoptic cameras.

It should be understood that while the application mentions use of cameras in endoscopic devices in various embodiments, such endoscopic devices can alternatively include other types sensors including, but not limited to, time of flight sensors and structured light sensors. In various embodiments, a structured pattern may be projected from a structured light source. In various embodiments, the projected pattern may change shape, size, and/or spacing of pattern features when projected on a surface. In various embodiments, one or more cameras (e.g., digital cameras) may detect these changes and determine positional information (e.g., depth information) based on the changes to the structured light pattern given a known pattern stored by the system. For example, the system may include a structured light source (e.g., a projector) that projects a specific structured pattern of lines (e.g., a matrix of dots or a series of stripes) onto the surface of an object (e.g., an anatomical structure). The pattern of lines produces a line of illumination that appears distorted from other perspectives than that of the source and these lines can be used for geometric reconstruction of the surface shape, thus providing positional information about the surface of the object.

In various embodiments, range imaging may be used with the systems and methods described herein to determine positional and/or depth information of a scene, for example, using a range camera. In various embodiments, one or more time-of-flight (ToF) sensors may be used. In various embodiments, the time-of-flight sensor may be a flash LIDAR sensor. In various embodiments, the time-of-flight sensor emits a very short infrared light pulse and each pixel of the camera sensor measures the return time. In various embodiments, the time-of-flight sensor can measure depth of a scene in a single shot. In various embodiments, other range techniques that may be used to determine position and/or depth information include: stereo triangulation, sheet of light triangulation, structured light, interferometry and coded aperture. In various embodiments, a 3D time-of-flight laser radar includes a fast gating intensified charge-coupled device (CCD) camera configured to achieve sub-millimeter depth resolution. In various embodiments, a short laser pulse may illuminate a scene, and the intensified CCD camera opens its high speed shutter. In various embodiments, the high speed shutter may be open only for a few hundred picoseconds. In various embodiments, 3D ToF information may be calculated from a 2D image series which was gathered with increasing delay between the laser pulse and the shutter opening.

In various embodiments, various types of signals (also called carriers) are used with ToF, such as, for example, sound and/or light. In various embodiments, using light sensors as a carrier may combine speed, range, low weight, and eye-safety. In various embodiments, infrared light may provide for less signal disturbance and easier distinction from natural ambient light, resulting in higher-performing sensors for a given size and weight. In various embodiments, ultrasonic sensors may be used for determining the proximity of objects (reflectors). In various embodiments, when ultrasonic sensors are used in a Time-of-Flight sensor, a distance of the nearest reflector may be determined using the speed of sound in air and the emitted pulse and echo arrival times.

While an image console can provide a limited three-dimensional image based on stereo imaging or based on a depth field camera, a basic stereo or depth field view does not provide comprehensive spatial awareness for the surgeon.

Accordingly, various embodiments of the present disclosure provide for generation of synthetic three-dimensional imaging from partial depth maps.

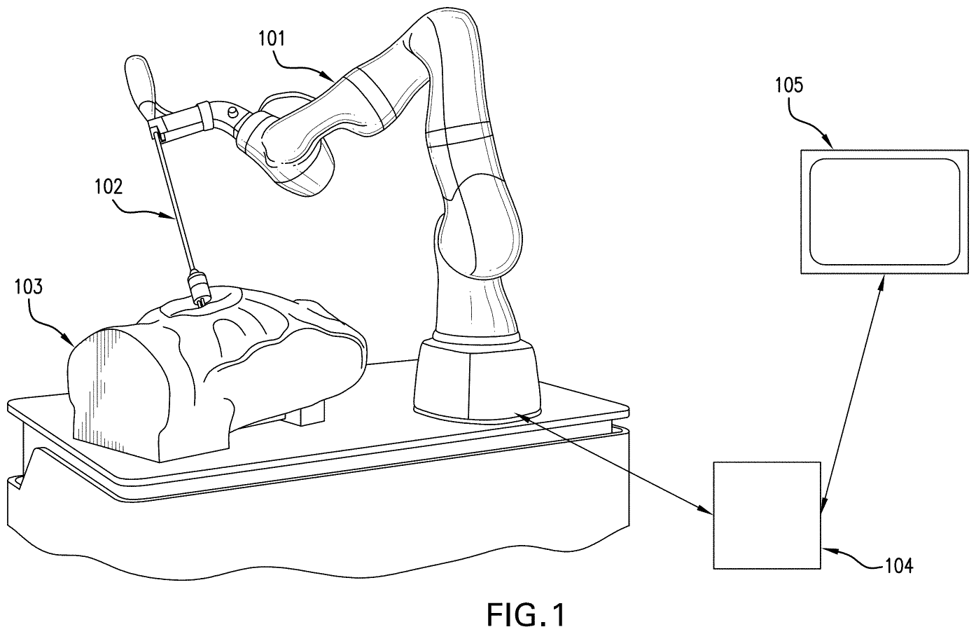

Referring to FIG. 1, an exemplary robotic surgery setup is illustrated according to the present disclosure. Robotic arm 101 deploys scope 102 within abdomen 103. A digital image is collected via scope 102. In some embodiments, a digital image is captured by one or more digital cameras at the scope tip. In some embodiments, a digital image is captured by one or more fiber optic element running from the scope tip to one or more digital camera elsewhere.

The digital image is provided to computing node 104, where it is processed and then displayed on display 105.

In some embodiments, each pixel is paired with corresponding depth information. In such embodiments, each pixel of the digital image is associated with a point in three-dimensional space. According to various embodiments, the pixel value of the pixels of the digital image may then be used to define a point cloud in space. Such a point cloud may then be rendered using techniques known in the art. Once a point cloud is defined, it may be rendered from multiple vantage points in addition to the original vantage of the camera. Accordingly, a physician may then rotate, zoom, or otherwise change a synthetic view of the underlying anatomy. For example, a synthetic sideview may be rendered, allowing the surgeon to obtain more robust positional awareness than with a conventional direct view.

In various embodiments, the one or more cameras may include depth sensors. For example, the one or more cameras may include a light-field camera configured to capture depth data at each pixel. In various embodiments, the depth sensor may be separate from the one or more cameras. For example, the system may include a digital camera configured to capture a RGB image and the depth sensor may include a light-field camera configured to capture depth data.

In various embodiments, the one or more cameras may include a stereoscopic camera. In various embodiments, the stereoscopic camera may be implemented by two separate cameras. In various embodiments, the two separate cameras may be disposed at a predetermined distance from one another. In various embodiments, the stereoscopic camera may be located at a distal-most end of a surgical instrument (e.g., laparoscope, endoscope, etc.). Positional information, as used herein, may generally be defined as (X, Y, Z) in a three-dimensional coordinate system.

In various embodiments, the one or more cameras may be, for example, infrared cameras, that emit infrared radiation and detect the reflection of the emitted infrared radiation. In other embodiments, the one or more cameras may be digital cameras as are known in the art. In other embodiments, the one or more cameras may be plenoptic cameras. In various embodiments, the one or more cameras (e.g., one, two, three, four, or five) may be capable of detecting a projected pattern(s) from a source of structured light (e.g., a projector). The one or more cameras may be connected to a computing node as described in more detail below. Using the images from the one or more cameras, the computing node may compute positional information (X, Y, Z) for any suitable number of points along the surface of the object to thereby generate a depth map of the surface.

In various embodiments, the one or more cameras may include a light-field camera (e.g., a plenoptic camera). The plenoptic camera may be used to generate accurate positional information for the surface of the object by having appropriate zoom and focus depth settings

In various embodiments, one type of light-field (e.g., plenoptic) camera that may be used according to the present disclosure uses an array of micro-lenses placed in front of an otherwise conventional image sensor to sense intensity, color, and directional information. Multi-camera arrays are another type of light-field camera. The “standard plenoptic camera” is a standardized mathematical model used by researchers to compare different types of plenoptic (or light-field) cameras. By definition the “standard plenoptic camera” has microlenses placed one focal length away from the image plane of a sensor. Research has shown that its maximum baseline is confined to the main lens entrance pupil size which proves to be small compared to stereoscopic setups. This implies that the “standard plenoptic camera” may be intended for close range applications as it exhibits increased depth resolution at very close distances that can be metrically predicted based on the camera's parameters. Other types/orientations of plenoptic cameras may be used, such as focused plenoptic cameras, coded aperture cameras, and/or stereo with plenoptic cameras.

In various embodiments, the resulting depth map including the computed depths at each pixel may be post-processed. Depth map post-processing refers to processing of the depth map such that it is useable for a specific application. In various embodiments, depth map post-processing may include accuracy improvement. In various embodiments, depth map post-processing may be used to speed up performance and/or for aesthetic reasons. Many specialized post-processing techniques exist that are suitable for use with the systems and methods of the present disclosure. For example, if the imaging device/sensor is run at a higher resolution than is technically necessary for the application, sub-sampling of the depth map may decrease the size of the depth map, leading to throughput improvement and shorter processing times. In various embodiments, subsampling may be biased. For example, subsampling may be biased to remove the depth pixels that lack a depth value (e.g., not capable of being calculated and/or having a value of zero). In various embodiments, spatial filtering (e.g., smoothing) can be used to decrease the noise in a single depth frame, which may include simple spatial averaging as well as non-linear edge-preserving techniques. In various embodiments, temporal filtering may be performed to decrease temporal depth noise using data from multiple frames. In various embodiments, a simple or time-biased average may be employed. In various embodiments, holes in the depth map can be filled in, for example, when the pixel shows a depth value inconsistently. In various embodiments, temporal variations in the signal (e.g., motion in the scene) may lead to blur and may require processing to decrease and/or remove the blur. In various embodiments, some applications may require a depth value present at every pixel. For such situations, when accuracy is not highly valued, post processing techniques may be used to extrapolate the depth map to every pixel. In various embodiments, the extrapolation may be performed with any suitable form of extrapolation (e.g., linear, exponential, logarithmic, etc.).

In various embodiments, two or more frames may be captured by the one or more cameras. In various embodiments, the point cloud may be determined from the two or more frames. In various embodiments, determining the point cloud from two or more frames may provide for noise reduction. In various embodiments, determining the point cloud from two or more frames may allow for the generation of 3D views around line of sight obstructions.

In various embodiments, a point cloud may be determined for each captured frame in the two or more frames. In various embodiments, each point cloud may be aligned to one or more (e.g., all) of the other point clouds. In various embodiments, the point clouds may be aligned via rigid body registration. In various embodiments, rigid body registration algorithms may include rotation, translation, zoom, and/or shear. In various embodiments, the point clouds may be aligned via deformable registration. In various embodiments, deformable registration algorithms may include the B-spline method, level-set motion method, original demons method, modified demons method, symmetric force demons method, double force demons method, deformation with intensity simultaneously corrected method, original Horn-Schunck optical flow, combined Horn-Schunck and Lucas-Kanade method, and/or free-form deformation method.

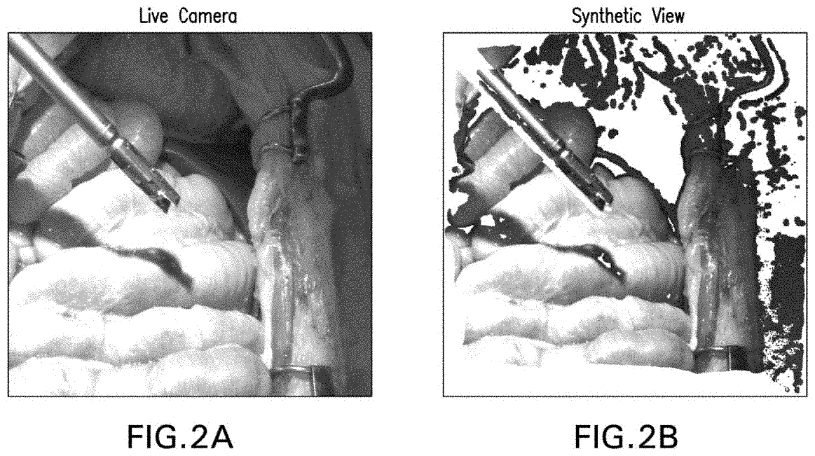

Referring to FIG. 2, a first synthetic view is illustrated according to embodiments of the present disclosure. FIG. 2A shows an original source image. FIG. 2B shows a rendered point cloud assembled from the pixels of the original image and the corresponding depth information.

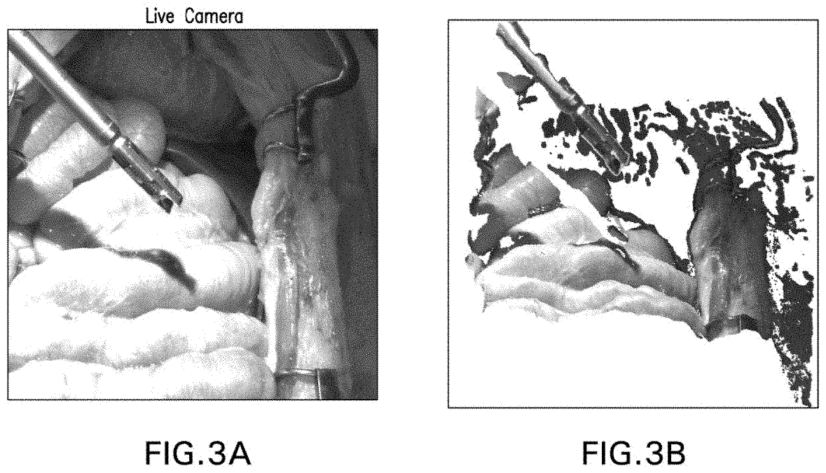

Referring to FIG. 3, a second synthetic view is illustrated according to embodiments of the present disclosure. FIG. 3A shows an original source image. FIG. 3B shows a rendered point cloud assembled from the pixels of the original image and the corresponding depth information. In the view of FIG. 3B, the subject is rotated so as to provide a sideview.

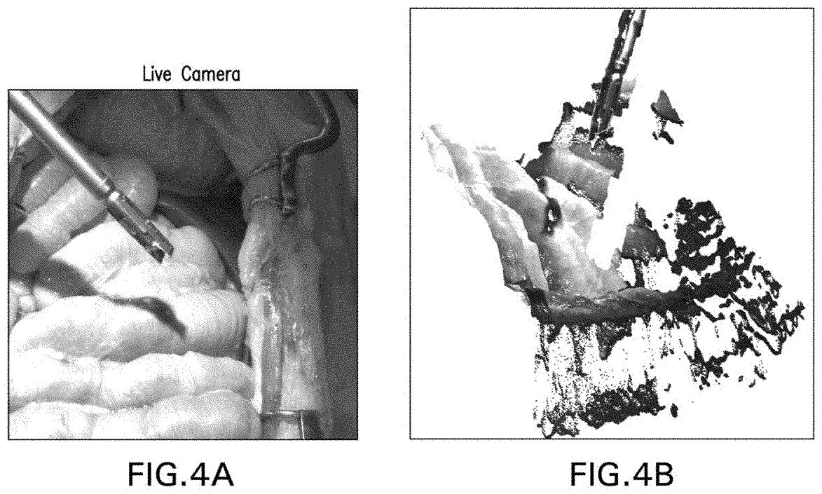

Referring to FIG. 4, a third synthetic view is illustrated according to embodiments of the present disclosure. FIG. 4A shows an original source image. FIG. 4B shows a rendered point cloud assembled from the pixels of the original image and the corresponding depth information. In the view of FIG. 4B, the subject is rotated so as to provide a sideview.

In various embodiments, a 3D surface mesh may be generated from any of the 3D point clouds. In various embodiments, the 3D surface mesh may be generated by interpolation of a 3D point cloud (e.g., directly or on a grid). In various embodiments, a 3D surface mesh may perform better when zooming in/out of the rendered mesh.

In various embodiments, semantic segmentation may be performed on a 3D surface mesh to thereby smooth out any 3D artifacts that may occur at anatomical boundaries. In various embodiments, prior to generation of a 3D mesh, the point cloud can be segmented into two or more semantic regions. For example, a first semantic region may be identified as a first 3D structure (e.g., liver), a second semantic region may be identified as a second 3D structure (e.g., stomach), and a third semantic region may be identified as a third 3D structure (e.g., a laparoscopic instrument) in a scene. In various embodiments, an image frame may be segmented using any suitable known segmentation technique. In various embodiments, point clouds for each identified sematic region may be used to generate separate 3D surface meshes for each semantic region. In various embodiments, each of the separate 3D surface meshes may be rendered in a single display to provide the geometry of the imaged scene. In various embodiments, presenting the separate meshes may avoid various artifacts that occur at the boundaries of defined regions (e.g., organs).

In various embodiments, because the rendered point cloud from the depth map provides a 3D depiction of the viewable surface, the point cloud may be augmented with one or more model of the approximate or expected shape of a particular object in the image. For example, when a point cloud of an organ (e.g., a kidney) is rendered, the point cloud may be augmented with a virtual 3D model of the particular organ (e.g., a 3D model of the kidney). In various embodiments, a surface represented by the point cloud may be used to register the virtual 3D model of an object within the scene.

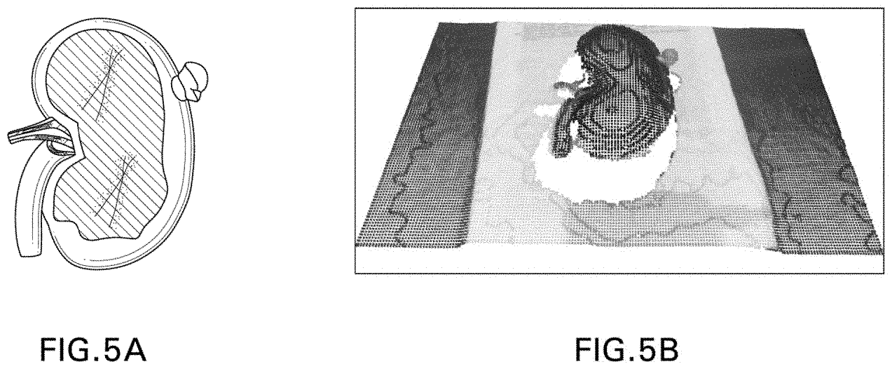

FIG. 5A shows a kidney 502 according to embodiments of the present disclosure. FIG. 5B shows a point cloud of the kidney shown in FIG. 5A according to embodiments of the present disclosure. In various embodiments, a point cloud 504 of a scene including the kidney 502 may be generated by imaging the kidney with a digital camera and/or a depth sensor.

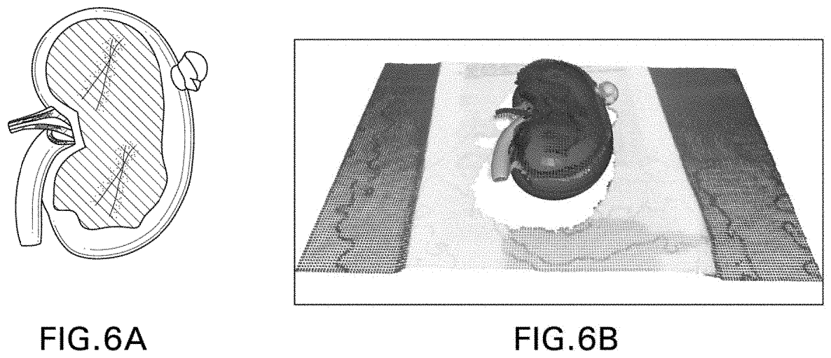

In various embodiments, the point cloud may be augmented via a virtual 3D model of an object (e.g., a kidney). FIG. 6A shows a kidney 602 according to embodiments of the present disclosure. A virtual 3D model 606 may be generated of the kidney 602 and applied to the point cloud 604 generated of the scene including the kidney 604. FIG. 6B shows an augmented point cloud of the kidney shown in FIG. 6A according to embodiments of the present disclosure. As shown in FIG. 6B, the virtual 3D model 606 of the kidney 602 is registered (i.e., aligned) with the point cloud 604 thereby providing additional geometric information regarding parts of the kidney 602 that are not seen from the perspective of the camera and/or depth sensor. In various embodiments, the virtual 3D model 606 is registered to the point cloud 604 using any suitable method as described above. FIG. 6B thus provides a better perspective view of an object (e.g., kidney 602) within the scene. In various embodiments, the virtual 3D model may be obtained from any suitable source, including, but not limited to, a manufacturer, a general anatomical atlas of organs, a patient's pre-operative 3D imaging reconstruction of the target anatomy from multiple viewpoints using the system presented in this disclosure, etc.

In various embodiments, the system may include pre-programmed clinical anatomical viewpoints (e.g., antero-posterior, medio-lateral, etc.). In various embodiments, the clinical anatomical viewpoints could be further tailored for the clinical procedure (e.g., right-anterior-oblique view for cardiac geometry). In various embodiments, rather than rotating the 3D view arbitrarily, the user may choose to present the 3D synthetic view from one of the pre-programmed viewpoints. In various embodiments, pre-programmed views may help a physician re-orient themselves in the event they lose orientation during a procedure.

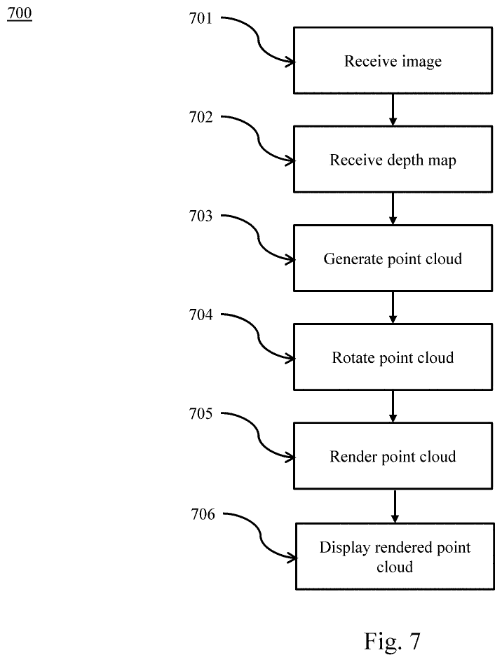

Referring to FIG. 7, a method for synthetic three-dimensional imaging is illustrated according to embodiments of the present disclosure. At 701, an image of an anatomical structure of a patient is received from a camera. At 702, a depth map corresponding to the image is received from a depth sensor. At 703, a point cloud corresponding to the anatomical structure is generated based on the depth map and the image. At 704, the point cloud is rotated in space. At 705, the point cloud is rendered. At 706, the rendered point cloud is displayed to a user.

In various embodiments, the systems and methods described herein may be used in any suitable application, such as, for example, diagnostic applications and/or surgical applications. As an example of a diagnostic application, the systems and methods described herein may be used in colonoscopy to image a polyp in the gastrointestinal tract and determine dimensions of the polyp. Information such as the dimensions of the polyp may be used by healthcare professionals to determine a treatment plan for a patient (e.g., surgery, chemotherapy, further testing, etc.). In another example, the systems and methods described herein may be used to measure the size of an incision or hole when extracting a part of or whole internal organ. As an example of a surgical application, the systems and methods described herein may be used in handheld surgical applications, such as, for example, handheld laparoscopic surgery, handheld endoscopic procedures, and/or any other suitable surgical applications where imaging and depth sensing may be necessary. In various embodiments, the systems and methods described herein may be used to compute the depth of a surgical field, including tissue, organs, thread, and/or any instruments. In various embodiments, the systems and methods described herein may be capable of making measurements in absolute units (e.g., millimeters).

Various embodiments may be adapted for use in gastrointestinal (GI) catheters, such as an endoscope. In particular, the endoscope may include an atomized sprayer, an IR source, a camera system and optics, a robotic arm, and an image processor.

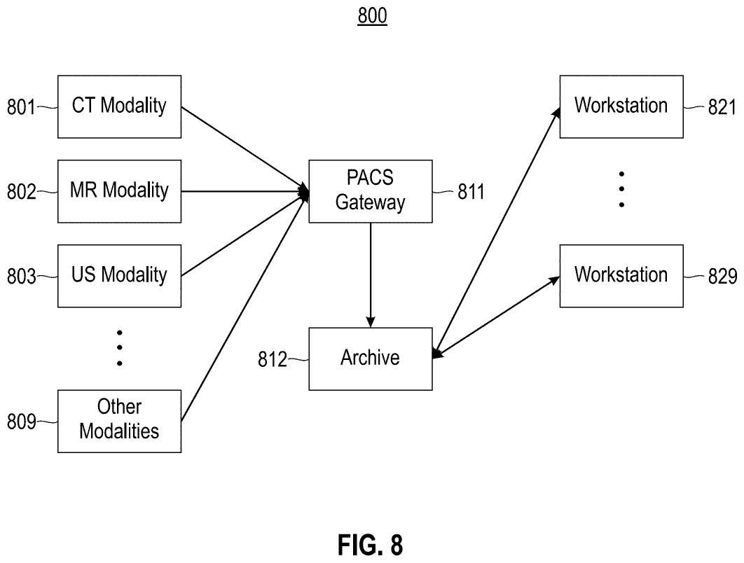

Referring to FIG. 8, an exemplary PACS 800 consists of four major components. Various imaging modalities 801 . . . 809 such as computed tomography (CT) 801, magnetic resonance imaging (MM) 802, or ultrasound (US) 803 provide imagery to the system. In some implementations, imagery is transmitted to a PACS Gateway 811, before being stored in archive 812. Archive 812 provides for the storage and retrieval of images and reports. Workstations 821 . . . 829 provide for interpreting and reviewing images in archive 812. In some embodiments, a secured network is used for the transmission of patient information between the components of the system. In some embodiments, workstations 821 . . . 829 may be web-based viewers. PACS delivers timely and efficient access to images, interpretations, and related data, eliminating the drawbacks of traditional film-based image retrieval, distribution, and display.

A PACS may handle images from various medical imaging instruments, such as X-ray plain film (PF), ultrasound (US), magnetic resonance (MR), Nuclear Medicine imaging, positron emission tomography (PET), computed tomography (CT), endoscopy (ES), mammograms (MG), digital radiography (DR), computed radiography (CR), Histopathology, or ophthalmology. However, a PACS is not limited to a predetermined list of images, and supports clinical areas beyond conventional sources of imaging such as radiology, cardiology, oncology, or gastroenterology.

Different users may have a different view into the overall PACS system. For example, while a radiologist may typically access a viewing station, a technologist may typically access a QA workstation.

In some implementations, the PACS Gateway 811 comprises a quality assurance (QA) workstation. The QA workstation provides a checkpoint to make sure patient demographics are correct as well as other important attributes of a study. If the study information is correct the images are passed to the archive 812 for storage. The central storage device, archive 812, stores images and in some implementations, reports, measurements and other information that resides with the images.

Once images are stored to archive 812, they may be accessed from reading workstations 821 . . . 829. The reading workstation is where a radiologist reviews the patient's study and formulates their diagnosis. In some implementations, a reporting package is tied to the reading workstation to assist the radiologist with dictating a final report. A variety of reporting systems may be integrated with the PACS, including those that rely upon traditional dictation. In some implementations, CD or DVD authoring software is included in workstations 821 . . . 829 to burn patient studies for distribution to patients or referring physicians.

In some implementations, a PACS includes web-based interfaces for workstations 821 . . . 829. Such web interfaces may be accessed via the internet or a Wide Area Network (WAN). In some implementations, connection security is provided by a VPN (Virtual Private Network) or SSL (Secure Sockets Layer). The client side software may comprise ActiveX, JavaScript, or a Java Applet. PACS clients may also be full applications which utilize the full resources of the computer they are executing on outside of the web environment.

Communication within PACS is generally provided via Digital Imaging and Communications in Medicine (DICOM). DICOM provides a standard for handling, storing, printing, and transmitting information in medical imaging. It includes a file format definition and a network communications protocol. The communication protocol is an application protocol that uses TCP/IP to communicate between systems. DICOM files can be exchanged between two entities that are capable of receiving image and patient data in DICOM format.

DICOM groups information into data sets. For example, a file containing a particular image, generally contains a patient ID within the file, so that the image can never be separated from this information by mistake. A DICOM data object consists of a number of attributes, including items such as name and patient ID, as well as a special attribute containing the image pixel data. Thus, the main object has no header as such, but instead comprises a list of attributes, including the pixel data. A DICOM object containing pixel data may correspond to a single image, or may contain multiple frames, allowing storage of cine loops or other multi-frame data. DICOM supports three- or four-dimensional data encapsulated in a single DICOM object. Pixel data may be compressed using a variety of standards, including JPEG, Lossless JPEG, JPEG 2000, and Run-length encoding (RLE). LZW (zip) compression may be used for the whole data set or just the pixel data.

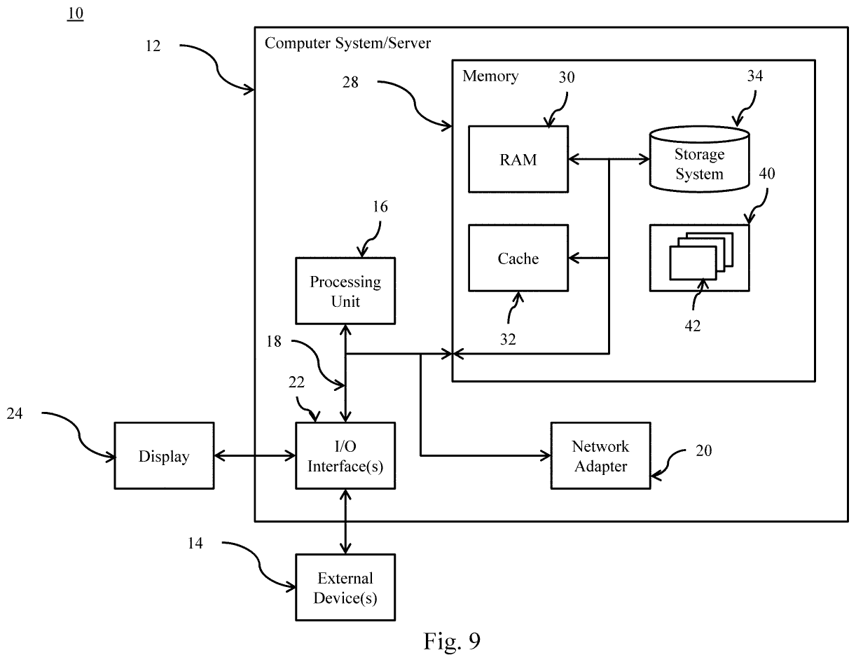

Referring now to FIG. 9, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 9, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1.-78. (canceled)

79. A method comprising:
(a) obtaining a plurality of images of an anatomical structure of a patient and a plurality of depth maps corresponding to the plurality of images;
(b) generating a point cloud corresponding to the anatomical structure using the plurality of images and the plurality of depth maps, wherein each point in the point cloud comprises a depth value derived from the one or more depth maps and a color value derived from the one or more images; and
(c) rendering and displaying the point cloud such that the point cloud is capable of being (i) manipulated by a user in three-dimensional space and (ii) viewed from a plurality of preprogrammed viewpoints.

80. The method of claim 79, wherein the point cloud is capable of being rotated in three-dimensional space in order to provide a visualization of the anatomical structure from one or more viewpoints of interest.

81. The method of claim 79, wherein the plurality of preprogrammed viewpoints are tailored for one or more procedures to assist in re-orientating a physician during the one or more procedures.

82. The method of claim 79, further comprising, subsequent to (a), post-processing the plurality of depth maps to reduce noise in one or more depth frames, wherein post-processing comprises at least one of spatial filtering and temporal filtering.

83. The method of claim 82, wherein spatial filtering comprises updating one or more depth values using depth data associated with one or more pixels in a single frame.

84. The method of claim 82, wherein temporal filtering comprises updating one or more depth values using depth data associated with one or more pixels in a plurality of frames.

85. The method of claim 79, further comprising, subsequent to (b), rotating the point cloud.

86. The method of claim 79, wherein (b) further comprises generating a plurality of point clouds comprising the point cloud and aligning the plurality of point clouds relative to each other.

87. The method of claim 86, wherein (c) further comprises rendering and displaying the plurality of aligned point clouds to the user.

88. The method of claim 86, wherein each of the plurality of points clouds corresponds to different image frames associated with different perspective views of the anatomical structure.

89. The method of claim 86, wherein aligning the plurality of points clouds comprises registering the points clouds using a rigid body registration or a deformable registration.

90. The method of claim 79, wherein in (b), the point cloud is generated using data from two or more image frames.

91. The method of claim 79, wherein the point cloud is a preliminary point cloud, wherein the method further comprises registering the preliminary point cloud with a model of the anatomical structure and generating an augmented point cloud from the preliminary point cloud and the model.

92. The method of claim 91, further comprising:
receiving from the user an indication to rotate the augmented point cloud;
rotating the augmented point cloud in space according to the indication; and
rendering and displaying the augmented point cloud to the user.

93. The method of claim 91, further comprising generating a surface mesh from the preliminary point cloud.

94. The method of claim 93, wherein generating the surface mesh comprises interpolating the preliminary point cloud.

95. The method of claim 93, further comprising, prior to generating the surface mesh, segmenting the preliminary point cloud into two or more semantic regions.

96. The method of claim 95, wherein generating the surface mesh comprises generating separate surface meshes for each of the two or more semantic regions.

97. The method of claim 96, further comprising combining the separate surface meshes into a combined surface mesh and displaying the combined surface mesh to the user.

98. The method of claim 91, wherein the model of the anatomical structure comprises a virtual three-dimensional (3D) model or an anatomical atlas, wherein the model of the anatomical structure corresponds to at least one of (i) pre-operative imaging of the patient or (ii) a three-dimensional (3D) reconstruction based at least in part on the pre-operative imaging.
